(19) United States
(12) Patent Application Publication
(10) Pub. No.: US 2004/0002891 A1
(43) Pub. Date: Jan. 1, 2004

(54) Internet-enabled system and method for modeling economics environments

(76) Inventors: Kay-Yut Chen, Santa Clara, CA (US); Leslie R. Fine, Menlo Park, CA (US); Ren Wu, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/184,480

(22) Filed: Jun. 27, 2002

(51) Int. Cl. G06F 17/60

(52) U.S. Cl. 705/10

(57) ABSTRACT

An on-line system allows remotely located human subjects to participate in sessions that simulate activities within an economics environment. The system includes an Internet-based interface, which may be web-enabled to allow the presentation of information using a graphical user interface compatible with the World Wide Web. The system simultaneously hosts multiple sessions in which business models are simulated. Information acquired during the sessions may be evaluated to enable informed decisions to be made regarding actual business variables.

### TECHNICAL FIELD

The invention relates generally to economics models and more particularly to systems and methods for modeling economics environments.

### BACKGROUND ART

Within any industry, the different businesses within the industry establish policies with the intent of achieving particular business objectives. In addition to setting prices, procedures must consider policies relating to advertising and to providing incentives for retailers. Many producers conduct a substantial percentage of their consumer business through retail channels. Thus, the relationship between the producer and its retailers is an important one. However, it is difficult to determine the effects that various policies will have on reaching business goals.

Under limited circumstances, a business may use a test market to acquire information regarding how policy changes will affect business. Thus, a limited but actual marketplace is used to test pricing policies, as well as other types of policies. One drawback with the use of a test market is that the process is costly. Moreover, the life cycle of many products is so short that this type of testing is not feasible.

As an alternative to the use of a test market, laboratory experiments may be conducted. Various experimental economics simulation software packages have been developed to model specific types of business organizational structures. For example, a “smart market” may be designed as a computerized dispatch center that applies optimizing algorithms to the diverse and decentralized bids of buyers and the offers of producers and transporters, so as to create a supply and demand environment that yields prices and allocations. One concern with the laboratory testing is that it has limited flexibility. For example, it may not be possible to simulate a business environment that utilizes return policies, which can be an important incentive in aligning retailers with a manufacturer. Additionally, if a certain process characteristic is changed within the business environment, extensive reprogramming is often needed to effect the change within the test software. Another concern is that the participants must be willing to enter a laboratory at a given location and must spend a significant portion of a day at the location. This may limit the number of qualified people willing to participate.

A software program for experimental economics was developed at the Institute for Empirical Research in Economics at the University of Zurich, Switzerland. The program is referred to as the Zurich Toolbox for Readymade Economic Experiments, or simply Z-Tree. The software package enables development and implementation of economic experiments. Different experiments, such as double auctions or Dutch auctions, can be programmed in a relatively short period of time. However, the package suffers from many of the drawbacks that were previously described.

What is needed is a system and method that is accessible to participants, adaptive in its implementation, and substantially wide ranging in its ability to model available policies of an economics environment. As one example of a desired, but not critical, feature, the system and method may provide insights regarding the behavior of retailers with respect to the practice of setting a minimum advertised price (MAP), which is a lower bound on the price a retailer can advertise for a particular product. Often, a MAP policy carries benefits or penalties contingent on the retailer's compliance or non-compliance with the MAP policy. It is not intuitively clear as to what form of MAP, if any, is best suited for a particular industry or what enforcement policy is most effective. The system and method should be extendible as a research tool for testing economic theory and game theory and for evaluating innovative economics and business mechanisms.

### SUMMARY OF THE INVENTION

Human subjects participate in sessions which simulate activities within an economics environment by using an Internet-based interface that permits the simulation participants to enter decision inputs from remote clients. The system simultaneously hosts multiple sessions, so that it is possible to test and evaluate the economics effects of the decisions. For example, each simulation participant may represent a different retailer who is able to remotely enter decision inputs regarding business opportunities and policies, where the opportunities and policies are defined by economics rules that were previously developed.

The Internet-based interface may be compatible with Transmission Control Protocol/Internet Protocol (TCP/IP) communications and may be specific to the World Wide Web. In such an application, the remote clients used by simulation participants may be written in Java language that is loaded dynamically when the participants log into their respective accounts through a web server. Participation is then compatible with any web browser, so that no special software need be loaded onto the computer of a participant. By identifying a particular participant, the communications that are sent to individual clients may be specifically selected to be compatible with the operating systems of the clients.

The web server supports a number of different functionalities. Firstly, access control is implemented through the web server. Thus, login procedures are executed through this component of the system. Additionally, this component supports loading of the appropriate interface Java scripts to the client machines Another functionality supported by the web server is the ability to provide training. Simulation participants may be presented with an overview of the session as a preliminary to the “experiment.” The training segment may be carried out simultaneously for a group of simulation participants who are to engage in a single experiment.

A scripting engine is configured to be responsive to the decision inputs received from the individual simulation participants. The scripting engine implements the economics rules, so that for each simulation participant a script is executed dynamically on the basis of the decision inputs from the participant and, less directly, on decision inputs from the other participants.

As another aspect of the invention, the system is designed as a script-based integrated development environment that enables remote model building. In addition to an Internet-based interface, which is preferably a web-enabled interface, the development components include a debugger for detecting errors (such as errors of omission, commission or syntax), an editor for programming scripts, and a visual code generator that provides graphical user interface (GUI) capability. Thus, this aspect of the invention is a GUI-driven economics model builder.

In place of the human participants, “robot” participants may be used in a simulation in which the different connections to participants are made via the Internet-based interface. Thus, in addition to enabling humans to act as players in a simulation, a software agent or robot may act in a person's behalf.

The method of enabling modeling of an economics environment includes storing the economics rules which define the business policies. The storage may include a core set of functionalities and a library of script functions. Thus, a modeling library is provided for development of alternative models. After a model has been developed, a number of simulations can be executed via Internet connectivity. Within each simulation, a script is followed on the basis of the economics rules, with the script varying dynamically on the basis of consequences (i.e., “payments”) as simulation participants select among business decisions. The business decisions and economics rules may be specific to at least one of a return policy, an advertising policy, and a minimum advertised price policy. Since the simulations are executed via the Internet, the simulation participants may be located at remote clients. As the simulations are conducted, results are stored, so that the results are available for evaluation in the selection of an economics strategy.

As another feature, the system may include a capability to compensate participants, thereby controlling the incentive in experiments. As an example, in an economics policy experiment, human subjects who play roles as retailers may be paid in spendable local currency at the conclusion of the experiment. An individual's payment could be based upon profits of the retail business represented by that individual, so as to motivate the individual to do well. The system can be configured to include an automatic payment capability and an automatic capability to maintain a database in which the payments are entered.

In addition to the simulation participants, other users of the system may use the Internet connectivity. For example, a developer may remotely generate the scripts which define a particular model. Additionally, an Internet-based monitor may be remotely located as a special interface that is used by a person or persons managing a model to perform such functions as scheduling simulation sessions, starting and stopping the sessions, and managing sessions by monitoring outgoing data in real time and by setting experimental parameters dynamically. The monitor also may be used to manage experimental data and to obtain reports of past sessions. As another possible remote component, an Internet-based observer may be used in the same manner as the monitor, but only for the passive activities, such as observing outgoing data in real time and managing the session data after it has been acquired.

An advantage of the invention is that the core set of functionalities and the extendible library of script functions allow the system to be sufficiently flexible to permit simulation of the impact of different return policies or different minimum advertized price policies. Moreover, the system is easily adapted to new situations. Another advantage of the invention is that multi-user, multi-stage software may be employed to support multiple simultaneous simulation sessions using Internet accessibility and allowing the simulation participant to utilize the operating system of his or her choice. The invention is extremely scalable, enabling one desktop personal computer to handle thousands of clients (participants) with a high interaction-to-interaction speed. Moreover, a GUI-driven capability is used, rather than a text-only interface. Yet another advantage is that the use of the Internet reduces the difficulty in recruiting participants, since laboratory attendance is no longer required.

### BRIEF DESCRIPTION OF THE DRAWINGS

FIG. 1 is a block diagram of a system for modeling an economics environment in accordance with the invention.

FIG. 2 is a block diagram of the database arrangement for the system of FIG. 1.

FIG. 3 is a block diagram of components used by developers of economics models that are to be accessible using the system of FIG. 1.

FIG. 4 is a process flow of steps for operating the system of FIG. 1.

### DETAILED DESCRIPTION

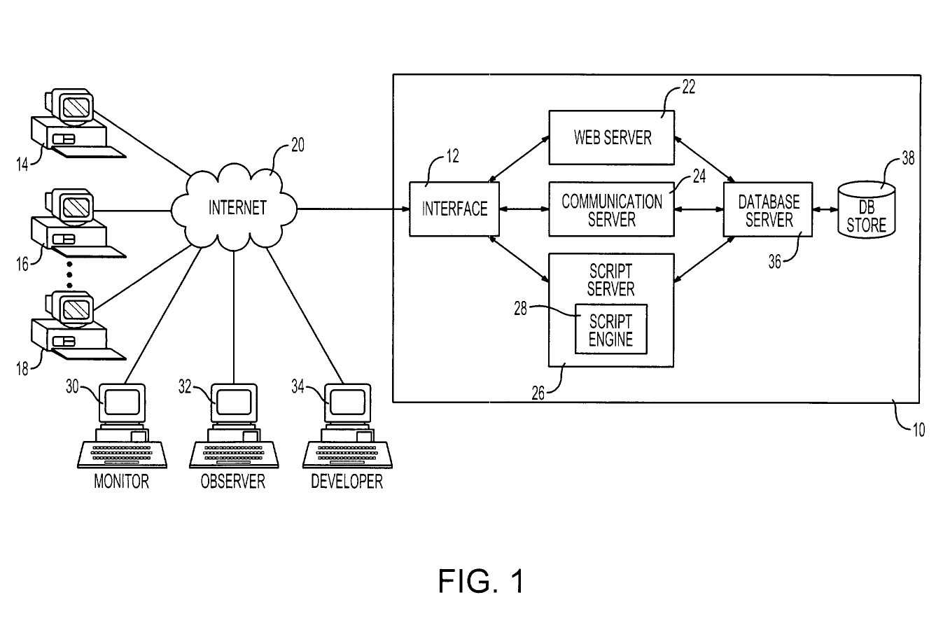

With reference to FIG. 1, a system for modeling an economics environment includes a central facility 10 having components for modeling an economics environment, such as a model of the relationship between a manufacturer and its retailers. The central facility includes an Internet-based interface 12 that enables communication between the central facility and a number of remote clients 14, 16 and 18 via the global communications network referred to as the Internet 20. In the embodiment shown in FIG. 1, the interface 12 is a web-enabled device that is connected to a web server 22, a communications server 24, and a script server 26. Each client is programming executed within a computing device, such as a personal computer. The client may be written in Java script that is loaded dynamically when a human simulation participant logs into the central facility 10 through the web server 22. The screen displays and the functions of the clients are defined by script language and are configured dynamically by a scripting engine 28 within the script server 26.

For the example in which the system models interactions between manufacturers and retailers of competing products (e.g., the human simulation participants at the different clients 14, 16 and 18 represent individual retailers), actual consumer demand for the products is computer simulated using the components of the central facility 10. The retailers and the manufacturers interact repeatedly in competing for the simulated consumer demand for the products which are differentiated by price and manufacturer. The simulation participants (i.e., the retailers) make decisions about stocking, advertising and pricing. Each simulated “consumer” considers the best price available when deciding whether to buy a product, but the consumer is only aware of the products and prices to which it is exposed. For purposes of explanation, the products will be identified as being printers.

The “printer retailers” at the different clients 14, 16 and 18 may represent different types of retail businesses, such as national firms, mass merchants, clubs, Internet retailers, and PC direct/mail order companies (which are companies that sell printers as part of a complete personal computer system). Each retailer may choose a price for each product in competing for a percentage of the potential market for the products. In executing the model, most companies are able to increase the percentage of the potential market by advertising, but each type of retailer has a maximum exposure percentage and advertising is designed to yield diminishing marginal returns. Most of the retailers must make inventory decisions, with the cost of holding excess inventory balanced against a negative reputation if a retailer fails to meet most of the demand for a product, since a retailer-to-manufacturer return policy is available.

The modeling includes an outcome function and a payoff function. The outcome function determines the results for each retailer as a function of the decision variables. For example, sales and return volumes are determined as a function of the decision variables. The payoff function is a score or cost result used to evaluate the outcome for each retailer at a client 14, 16 and 18. The payoff function may be defined with respect to the different types of retailers, since different retailers may have significantly different goals. For example, out of all of the different types of retailers, the Internet retailer might place the highest priority on gaining exposure and a positive reputation, with a much lower priority on maximizing profit. Outcome measures may include combinations of gross profit, net income, revenue and market share.

The activities of the simulation participants are limited by economics rules. The economics rules define opportunities and policies, such as the availabilities of competing products, the return policy, the advertising policy, and the minimum advertised price (MAP) policy. A limitation imposed by the advertising policy prevents a participant from setting advertising expenditures greater than the participant's budget.

While not shown in FIG. 1, the clients 14, 16 and 18 may be connected to the Internet 20 via available Internet Service Providers (ISPs), as is well known in the art. Thus, TCP/IP communications are used in exchanging video information and decision inputs between the clients and the Internet-based interface 12 of the central facility 10. However, other protocols may be used without diverging from the scope of the invention.

The web server 22 enables a number of different functionalities. Access control is implemented through the web server. For example, each simulation participant may be required to follow a login procedure in order to initiate a session. The web server provides processing to load appropriate interface Java scripts to the client machines. The transmissions are designed and selected to be executed on the basis of the different platforms (e.g., operating systems) of the various client machines 14,16 and 18. Another functionality of the web server is to provide training for the simulation participants. A training segment may precede each session. The training includes the presentation of an overview of the session and a summarization of the mechanics involved in entering decision inputs, as well as the effects of the decision inputs. Moreover, the various policies may be introduced. As one example, the MAP violation penalties are presented as a chart of the penalties for each product. Possible penalties include pulling products (preventing a retailer from receiving further shipments of a product), suspending advertising funds for a number of time periods, and withdrawing advertising funds for the current period.

The communications server 24 enables communication functions to and from users. Such functions include, but are not limited to, chatting, email exchanges, mailing lists, and searchable knowledge base access. The communications may be with the client machines 14, 16 and 18, as well as computing devices identified as a monitor 30, an observer 32, and a developer 34. The functions of these three machines will be described below.

The scripting engine 28 executes scripts, which are software representations of the sessions. The script server 26 is the communication layer of the scripting engine. Each script is a business process flow, which may be considered to be a decision-based process tree of a series of nodes connected by a directed graph. The sequence of nodes that are visited during the running of a script for a particular simulation participant at a particular client machine will depend upon the decision inputs entered by the simulation participant. Moreover, the scripts enforce the economics rules under which the participants must abide. However, participants may be operating under different rules. For example, the scripts which display economics information to an Internet retailer may be significantly different than the information presented to retailers in more traditional settings. The scripts may act on decision inputs communicated from a simulation participant in real time. Alternatively, the scripts may condition the execution to wait until decision inputs are received from all simulation participants. The scripting engine 28 and script server 26 enable multi-user, multi-stage processing that allows a number of sessions to be executed simultaneously. This simultaneous execution significantly enhances the volume of useful information available as a result of the simulation. In some applications, the participants may include software agents or software robots, which are programmed to function in a person's behalf.

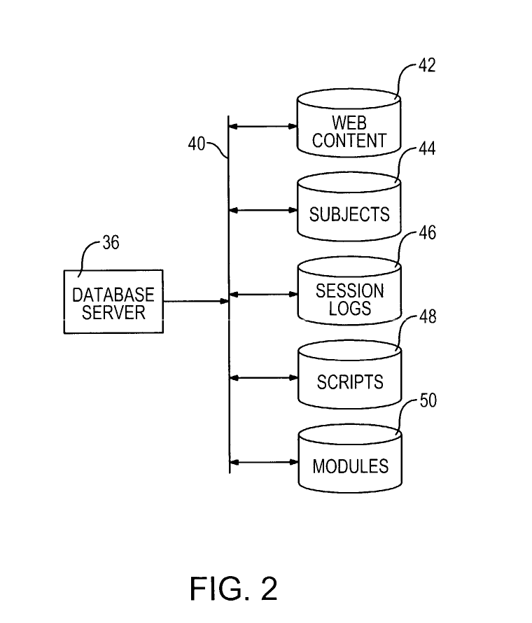

A database server 36 is connected to the other three servers 22, 24 and 26 of the central facility 10. The database server is connected to a number of different databases that are represented by a single database store 38. The individual database components are shown in FIG. 2. Each of the different database components is connected to a bus 40 to enable communication with the database server 36.

A web content database component 42 may be used to store the training material that is presented to simulation participants prior to a session. In addition, the web content database component includes access control information, such as passwords. For this reason, the information within the web content database component is correlated with information within a subjects database component 44. The subjects database component includes profile information of the individual subjects, such as participation information. The payment information may also be stored within this second database component. Compensation to individual participants may be at least partially based on performance of the business represented by the individuals. For example, in modeling a retail business environment, compensation for participation may be based on profits, so that the participants are motivated to do well. Thus, the system can be configured to automatically determine compensation based on performance and to automatically maintain compensation information in the subjects database component 44.

The information within the subjects database component 44 is correlated with data contained within a session logs database component 46. Data that is acquired during sessions is stored for subsequent evaluation. The data can then be used as a basis for business decisions in an actual marketplace. Within the modeling system, the data is correlated with scripts within a scripts database component 48. The scripts codify the substance and form of communication data between the simulation participants and the system. The scripts define and enforce economics rules, as was previously noted. A modules database component 50 cooperates with the scripts database module 48 in order to store libraries of script modules that are ready to be executed. Moreover, this last database component includes economics modeling information about the modules and any configuration information regarding the modules.

Referring again to FIG. 1, the monitor is a specific management interface that allows an “experimenter” to perform a number of functions at a site that is remote from the central facility 10. A user can schedule the simulation sessions, start the sessions, and stop the sessions. Thus, the monitor 30 may be used to recruit and assign simulation participants to sessions. Recruitment may involve filtering, such as admitting only those participants who performed well in previous experiments (e.g., the last five sessions). Moreover, the monitor may be used to query and filter information within the database store 38. For example, the subjects database component 44 of FIG. 2 may be remotely accessed using the monitor. Preferably, the subjects database identifies participant performances (e.g., earnings and experimental behavior) across multiple experiments. As another feature, the monitor may be used to observe data generated during sessions in real time. Experimental parameters may be set dynamically via the monitor and session data may be managed. Post-session data may be acquired through the monitor in the format of reports. Additionally, the monitor may be used to enforce general management.

The observer 32 is a special monitor, but only enables passive functions. For example, an observer station may allow a person to monitor data generated during an “experiment” in real time and may allow access to post-session data in the form of reports. However, active management of the experiments is not enabled by use of the observer. For both the monitor 30 and the observer 32, conventional personal computers may be loaded with the appropriate software programming.

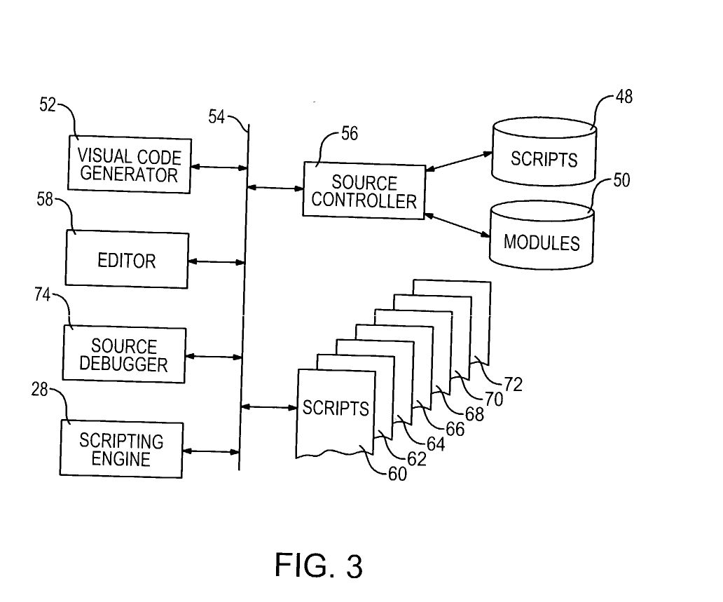

The developer 34 may be used to remotely access the development capability of the central facility 10. Components which cooperate to provide economics model development are shown in FIG. 3. A visual code generator 52 presents a GUI environment that allows a developer to “draw” an economics model and to create a skeletal code for that model. The central facility is not limited to text communications, either for development or for conducting ongoing sessions. The visual code generator is connected to a bus 54 to which the various components are also connected, including a source controller 56 which is linked to the scripts database component 48 and the modules database component 50.

An editor 58 is used for programming text editions which define an economics model. In FIG. 3, seven scripts 60, 62, 64, 66, 68, 70 and 72 are represented. The different scripts may be designed for presentation to different simulation participants within a single session. In the example in which the simulation participants represent retailers, the first script 60 may be designed to implement economics rules that are specific to a conventional retailer, while the second script 62 may be designed for economics rules for an Internet retailer.

A source debugger 74 is employed for debugging script development. The functionalities of the source debugger include (1) interactive step-wise execution of scripts 60-72, (2) inserting, deleting and managing break points within any one of the scripts, (3) dynamically interacting with the variables associated with the economics model, (4) syntax checking, and (5) error reporting. After the scripts 60-72 have been developed, they are stored within the scripts database component 48 for subsequent use.

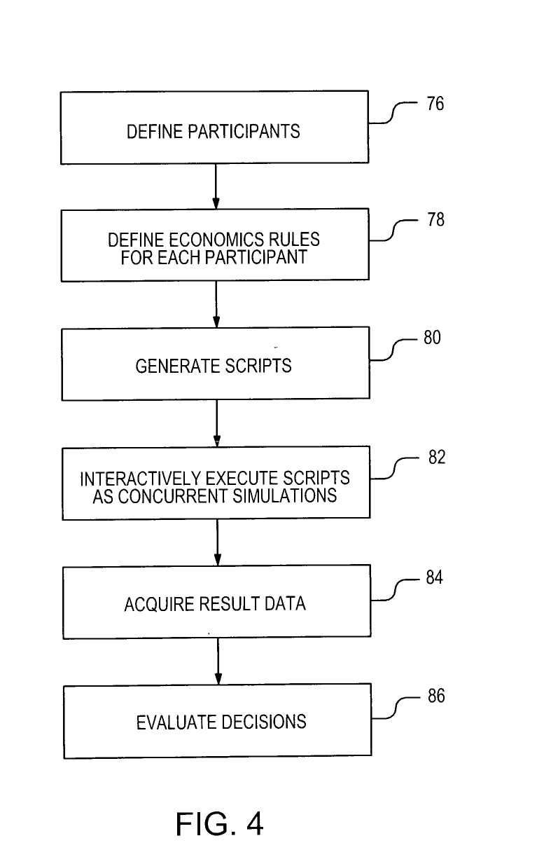

FIG. 4 identifies one sequence of steps for utilizing the system of FIG. 1 to determine the economics impact of different decisions through simulation. In step 76, one or more type of simulation participant is identified. For example, the participants may be types of retailers in a manufacturer/retailer economics model. In step 78, economics rules are defined for each participant. As previously noted, different rules apply to different participants. The rules set participants' economics behavior and may form a decision-making process tree. The outcome or payoff of a session is determined by the decisions entered by a participant in navigating through the decision-making process tree.

In step 80, the scripts are generated in accordance with the economics rules. The development environment of FIG. 3 may be accessed remotely to generate the scripts. The scripts are converted or compiled into data structures suitable for execution by simulation modules contained within the modules database component 50 of FIG. 2.

At step 82, the scripts are executed interactively as concurrent simulations. The interaction between simulation participants and the central facility 10 are governed by the simulation modules. During the simulations, result data is acquired, as indicated at step 84. The economics impact of a decision or the economics impact of a set of rules is determined from the results of the simulations. The participants may be financially rewarded, for example, by currency based on their performance, as determined by payoff and outcome functions. The various decisions are evaluated at step 86 as a basis for determining subsequent behavior in an actual marketplace.

As one example of a screen-driven application of the invention, a simulation participant representing a retailer may be presented with six different screens. The first screen is the order screen that offers each simulation participant with an opportunity to make purchases. The order screen may include other information, such as the amount of advertising for each product, the pricing, and the inventory. The second screen is the advertising screen which again presents pricing and inventory information, but states the amount available for advertising. Simulation participants choose advertising expenditures for each product.

A pricing screen allows simulation participants to select selling prices. This screen indicates any pricing restrictions. However, it should be noted that there may be no restrictions on prices, since a MAP policy applies to advertised prices, rather than actual selling prices.

A price-control-and-ad screen shows the advertising funds earned from the shipments received in a particular sales period, any amount lost in that sales period because of a MAP violation, and the number of sales periods remaining in the MAP penalty.

A fifth screen indicates the supply, demand and return for each product within a sales period. As previously noted, demand is computer simulated. The return policy may be based on a percentage, such as an allowable return of six percent of the cumulative shipments.

The final screen is the earnings-summary screen. It is at this point that the simulation participant's performance for the last sales period and the entire session is evaluated.

While the invention has been described with reference to an application in which the simulation participants represent retailers, the invention has numerous other applications. FIG. 1 is one embodiment of an on-line experimental electronics system (OEES) that manages and executes economics simulation with human subjects. The system can be used to test business processes, to investigate market institutions, to evaluate business policies, and, in general, to study any model of an economics system. One business application of the system is to generate data under different business models, and therefore provide scientific evaluations and comparisons of the different business models. The comparisons and evaluations may then be used to make informed decisions regarding business variables.

What is claimed is:

1. A system for modeling an economics environment comprising:
a store of economics rules specific to defining opportunities and policies that form decision-dependent interrelationships within said economics environment;
a scripting engine configured to be responsive to decision inputs from individual simulation participants in implementing said economics rules, said scripting engine having access to scripts which are executed dynamically by said scripting engine on a basis of said decision inputs; and
an Internet-based interface having access to the global communications network referred to as the Internet to enable said individual simulation participants to access said scripting engine from remote clients.

2. The system of claim 1 wherein said Internet-based interface is compatible with Transmission Control Protocol/Internet Protocol (TCP/IP) communications.

3. The system of claim 1 wherein said scripting engine is enabled to simultaneously support multiple simulation sessions in which said simulation sessions include receiving said decision inputs from different said remote clients.

4. The system of claim 3 further comprising a store of access control information specific to selecting said individual simulation participants, including enforcing subject filtering considerations.

5. The system of claim 1 further comprising a database of training information which is cooperative with said Internet-based interface for presenting on-line training material to said remote clients, wherein said on-line training material relates to enabling said individual simulation participants to interact with said scripting engine.

6. The system of claim 1 further comprising a stored library of script modules available to said scripting engine for execution.

7. The system of claim 1 wherein said economics rules of said store are specific to business processes related to at least one marketable product.

8. The system of claim 7 wherein said economics rules of said store include rules associated with policies related to at least one of a return policy, an advertising policy, and a minimum advertised price policy.

9. The system of claim 1 further comprising script development components configured to enable on-line generation of additional scripts via said Internet, said additional scripts then being accessible for execution by said scripting engine.

10. The system of claim 1 further comprising a monitor station cooperative with said store of economic rules and said scripting engine for managing interactions with said simulation participants.

11. A system for modeling an economics environment comprising:
a web-enabled interface configured to enable communications via the Internet;
an editor responsive to script editing commands received via said web-enabled interface for programming scripts that are interactive with respect to following sequences of business operations;
a visual code generator cooperative with said editor to enable remote computing devices to operate said editor via said web-enabled interface;
a script database of said scripts accessible by said editor; and
an engine cooperative with said database to enable interactive execution of said scripts by entering decisions from client computers connected to said engine via said web-enabled interface.

12. The system of claim 11 further comprising a source debugger enabled to detect errors in said scripts as a consequence of processing by said editor.

13. The system of claim 11 wherein said editor and said visual code generator are components of a Graphical User Interface (GUI) driven economics model builder, said system further comprising a modeling library that includes a core set of script functionalities.

14. The system of claim 11 further comprising a compensation database for determining compensation for participants at said client computers, where said compensation is based on said decisions entered by said participants.

15. A method of enabling modeling of an economics environment comprising:
storing economics rules which define business policies, said business policies including definitions of consequences of a plurality of business decisions;
enabling a plurality of simulations to be executed via Internet connectivity, including following scripts that are based on said economics rules and that vary dynamically on the basis of said consequences as simulation participants select said business decisions, said simulations being conducted by said simulation participants from remote clients via said Internet connectivity; and
storing results of said simulations such that said results are available for basing economics strategies thereon.

16. The method of claim 15 further comprising enabling developers to manipulate said economics rules via an Internet connection to development components associated with said economics rules and said scripts.

17. The method of claim 15 further comprising enabling a monitor station to remotely monitor said simulations in real time using a separate Internet connection and to remotely manage availability to initiate said simulations.

18. The method of claim 17 further comprising enabling an observer to access simulation data acquired during said simulations, said simulation data being specific to said results of said simulations, said enabling of said observer being provided via a specific Internet connection.

19. The method of claim 15 wherein enabling said plurality of simulations includes employing a multi-user server having TCP/IP connectivity to the Internet.

20. The method of claim 15 wherein enabling said plurality of simulations includes allowing at least one said simulation participant to be software driven in functioning on behalf of a human participant.

21. The method of claim 15 wherein storing includes providing economics rules specific to at least one of a return policy, an advertising policy, and a minimum advertised price policy.
